(19) United States
(12) Patent Application Publication
(10) Pub. No.: US 2011/0279393 A1
(43) Pub. Date: Nov. 17, 2011

(54) METHOD AND APPARATUS FOR CONTROLLING A DISPLAY UNIT OF A PORTABLE TERMINAL

(75) Inventors: Norio OKADA, Tokyo (JP); Jong Seong LEE, Tokyo (JP); Yuzuru MASUDA, Tokyo (JP)

(73) Assignee: SAMSUNG ELECTRONICS CO., LTD., Gyeonggi-Do (KR)

(21) Appl. No.: 13/099,675

(22) Filed: May 3, 2011

(30) Foreign Application Priority Data
May 13, 2010 (KR) 10-2010-0044840

(51) Int. Cl. G06F 3/041

(52) U.S. Cl. 345/173

(57) ABSTRACT

A method of controlling a display unit of a portable terminal includes receiving a signal corresponding to a user gesture from a touch sensor unit located in a peripheral area of the display unit; and activating or deactivating at least part of the display unit according to the signal received from the touch sensor unit.

### CLAIM OF PRIORITY

This application claims priority under 35 U.S.C. §119 from a Korean Patent Application entitled “Method and Apparatus for Controlling a Display Unit of a Portable Terminal” filed in the Korean Intellectual Property Office on May 13, 2010 and assigned Serial No. 10-2010-0044840, the contents of which are incorporated herein by reference.

### BACKGROUND OF THE INVENTION

1. Field of the Invention

The present invention relates to a method and an apparatus for controlling a display unit of a portable terminal, and more particularly, to a method and an apparatus for controlling a turn-on/turn-off function of at least part of the display unit according to a user gesture recognized through a touch sensor.

2. Description of the Related Art

Recently, with advancement of electronic technologies, a portable terminal provides various features which may include a voice call function, text messages, broadcast of media contents, a camera function, wireless internet and games. In essence, the portable terminal has become indispensable tool in a modern life.

When the portable terminal is not in use, a display unit is turned off to prevent unnecessary battery consumption. As such, in order to access information such as a text message, current time or an email, a user needs to activate a certain key, or open a folder type portable terminal, or slide an upper plate of a slide type portable terminal to turn on the display unit. These methods of turning on and off the display unit are used in most portable terminals. However, the conventional method of turning on and off the display unit is monotonous, lacking in uniqueness, and less entertaining.

### SUMMARY OF THE INVENTION

The present invention has been made in view of the above problems and provides additional advantages, by providing a method and an apparatus for controlling a display unit of a portable terminal in which turn-on/turn-off of at least part of the display unit is controlled in correspondence with a user gesture detected by a touch sensor, which is mounted in a peripheral area of the display unit. The inventive method of controlling the turn-on/turn-off of the display unit enables a user to use the portable terminal in a more entertaining way.

In accordance with an aspect of the present invention, a method of controlling a display unit of a portable terminal includes: receiving a signal corresponding to a user gesture from a touch sensor unit located in a peripheral area of the display unit; and activating or deactivating at least part of the display unit according to the signal received from the touch sensor unit.

In accordance with another aspect of the present invention, an apparatus for controlling a display unit of a portable terminal includes: a touch sensor unit located in a peripheral area of the display unit; and a controller configured to activate or deactivate at least part of the display unit according to a signal received from the touch sensor unit.

In accordance with an aspect of the present invention, a mobile telecommunication unit includes a display unit having a plurality of sensors in a horizontal or vertical orientation, the plurality of sensors defining a plurality of areas for sensing input information, and a controller configured to receive a signal indicative of movement detected by the plurality of sensors over the plurality of areas and to selectively activate or deactivate at least one of the plurality of areas corresponding to the received signal.

### BRIEF DESCRIPTION OF THE DRAWINGS

The above features and advantages of the present invention will be more apparent from the following detailed description in conjunction with the accompanying drawings, in which:

FIG. 1 is a schematic block diagram illustrating a configuration of a portable terminal according to an exemplary embodiment of the present invention;

FIG. 2 is a schematic view illustrating an exterior of a portable terminal according to an exemplary embodiment of the present invention;

FIG. 3 is a flowchart illustrating a method of controlling a display unit of a portable terminal according to an exemplary embodiment of the present invention;

FIGS. 4 through 7 are views illustrating an example screen display for explaining a method of controlling a display unit of a portable terminal according to an exemplary embodiment of the present invention;

FIG. 8 is a flowchart illustrating a method of controlling a display unit of a portable terminal according to another exemplary embodiment of the present invention; and

FIG. 9 is a view illustrating an example screen display for explaining a method of controlling a display unit of a portable terminal according to another exemplary embodiment of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

It will be appreciated that a portable terminal having a display unit according to exemplary embodiments of the present invention includes, for example, a mobile communication terminal, a personal digital assistant (PDA), a smart phone, a portable multimedia player (PMP), a PlayStation portable (PSP), an MP3, a laptop computer, or the like. In the following description, the portable terminal is assumed to be a mobile communication terminal, for illustrative purposes.

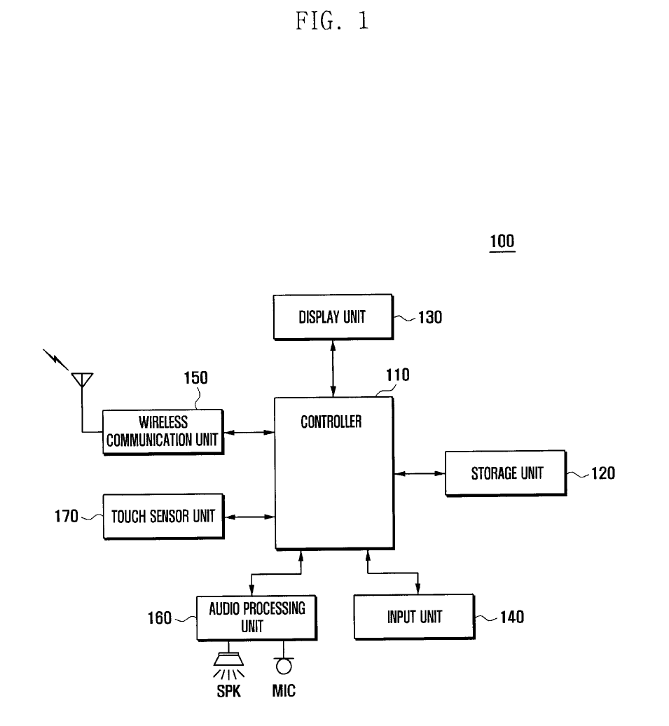

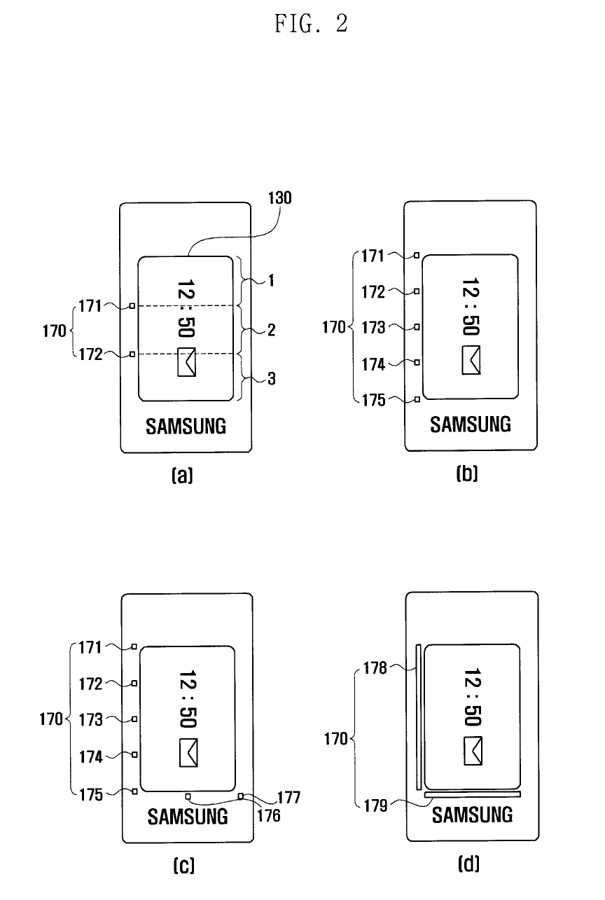

FIG. 1 is a schematic block diagram illustrating a configuration of a portable terminal 100 according to an exemplary embodiment of the present invention, and FIG. 2 is a schematic view illustrating an exterior of the portable terminal 100 according to an exemplary embodiment of the present invention.

Referring to FIGS. 1 and 2, the portable terminal 100 according to an exemplary embodiment of the present invention can include a controller 110, a storage unit 120, a display unit 130, an input unit 140, a wireless communication unit 150, an audio processing unit 160, and a touch sensor unit 170. In operation, the portable terminal 100 having the above configuration can detect a user gesture (e.g., scrolling the display unit 130) by using the touch sensor unit 170, thereby controlling on and off states of at least part of the display unit 130 in correspondence with the user gesture. Hereinafter, each element of the portable terminal 100 is described in detail below.

The wireless communication unit 150, under control of the controller 110, forms a communication channel for a voice communication as well as a communication channel for data communication. Namely, the wireless communication unit 150, in association with a mobile communication system, forms a voice call channel, a data communication channel, and a video call channel through a base station. To this end, the wireless communication unit 150 can include a radio frequency transmitting unit (not shown) for performing frequency up conversion and amplification of a transmission signal and a radio frequency receiving unit (not shown) for performing low noise amplification and frequency down conversion of a signal received. Further, the wireless communication unit 150 can receive a text message or an email. When at least part of the display unit 130 is turned on in response to the user gesture, a text message indication icon or the content of the text message can be displayed on a turn-on area of the display unit 130. In an alternate embodiment, the wireless communication unit 150 can be omitted when the portable terminal 100 according to the present invention does not support wireless communication.

The input unit 140 can include an input key and a function key for receiving numeral or character information, setting up various features, and controlling a function of the portable terminal 100. For example, the input unit 140 can include a voice key for requesting a voice call, a video key for requesting a video call, a disconnect key for requesting to end the voice call or the video call, a volume key for controlling an output volume of an audio signal, or an arrow key. In addition, the input unit 140 can include a function key (e.g., a hold key provided in a general bar type portable terminal) for switching between the on-state and the off-state of the display unit 130. Depending on a type of the portable terminal 100, the input unit 140 can be configured to include at least one of or a combination of a touch pad, a touch screen, a keypad having a general key layout, and a qwerty keypad.

The audio processing unit 160 includes a speaker SPK for reproducing an audio data transmitted and received during a call and a mike MIC for collecting a user's voice or other audio signals during the call. The audio processing unit 160 can output a corresponding audio signal when a screen status is changing. Particularly, when at least part of the display unit 130 is turned on or turned off according to the user gesture, the audio processing unit 160 according to the present invention can output a corresponding audio signal through the speaker SPK.

The display unit 130 displays information inputted by the user or information provided to the user as well as various menu items of the portable terminal 100. In other words, the display unit 130 can provide various screens according to the usage of the portable terminal 100. For example, the display unit 130 can provide a stand-by screen, a menu screen, a message writing screen, or a call screen. When the display unit 130 in the off state is turned on, the display unit 130 can display a number of predefined information, e.g., time, date, whether the user has an unread text message, or whether a manner mode is set up. Alternatively, when the display unit 130 displaying a particular screen is turned off after a given period of time elapses, the display unit 130 can output an image displayed when the display unit 130 is turned off.

The display unit 130 can be multiple depending on the type of the portable terminal 100. For example, if the display unit 130 is a folder type portable terminal, the display unit 130 can include a main display unit, which is viewable only when the folder is opened, and a sub display unit, which is viewable whether the folder is opened or closed. Particularly, in the display unit 130 according to the exemplary embodiment of the invention, at least part of the area of the display unit 130 can be turned on or turned off according to the user gesture detected by the touch sensor unit 170. Specifically, a part of the display unit 130 can be turned on or off successively (or step by step) in response to the user gesture scrolling over the display unit 130. Furthermore, the display unit 130 that performs the above function can be a liquid crystal display (LCD), an organic light emitted diode (OLED), or an active matrix organic light emitted diode (AMOLED). Also, when the display unit 130 is formed as a touch screen, the display unit 130 can function as the input unit 140.

The touch sensor unit 170 is a device that can detect a touch activation thereon and can transmit a corresponding signal to the controller 110 upon detecting a user's touch, dragging, or motion. The touch sensor unit 170 can include a capacitive type touch sensor that detects the touch by detecting a change of capacitance, a pressure touch sensor that detects the touch based on a pressure applied thereto, or an infrared touch sensor that detects the touch using a reflecting light. However, it should be noted that the present invention is not limited to these examples. Thus, the touch sensor unit 170 according to the present invention can include other type of sensors such as an optical sensor or a proximity sensor that can detect the user gesture.

The touch sensor unit 170 can be formed to include a plurality of touch sensors. Here, the touch sensors can be mounted on a peripheral area of the display unit 130, e.g., at least one of a top side, a bottom side, a left side, or a right side of the display unit 130. For example, as shown in (a) and (b) of FIG. 2, the plurality of the touch sensors 171, 172, 173, 174 and 175 can be mounted on the display unit 130 along a vertical direction and spaced apart by a predefined interval. Also, although not shown, the touch sensors 171, 172, 173, 174 and 175 can be mounted on the display unit 130 along a horizontal direction and spaced apart by a predefined interval. Alternatively, as shown in (c) of FIG. 2, a plurality of the touch sensors 171, 172, 173, 174, 175, 176 and 177 can be mounted on the display unit 130 in vertical and horizontal directions at an interval between one another. Further, as shown in (d) of FIG. 2, the touch sensor unit 170 can be formed to be elongated along at least one of the horizontal and vertical directions of the display unit 130 and can include a touch pad or a touch panel that can detect a touch position.

In addition to an operating system (OS) of the portable terminal 100, the storage unit 120 can store an application program for providing optional features such as reproducing a sound, an image, or a video; a user data; and a data transmitted and received. Particularly, the storage unit 120 according to the present invention can store an application program for controlling the on/off state of the at least part of the display unit 130 in correspondence with the user gesture.

The controller 110 can control an overall operation of the portable terminal 100, control signal flow between internal blocks of the portable terminal 100, and perform data processing. Particularly, the controller 110 according to the present invention can control a turn on/off of at least part of the display unit 130 in response to a signal inputted from the touch sensor unit 170. Here, the user gesture can be an act of scrolling the display unit 130 in a vertical or horizontal direction. For example, in response to the user gesture occurring in the display unit 130 in the turn off state, the controller 110 can turn on the display unit 130 step by step (or gradually). Specifically, as shown in (a) of FIG. 2, in a case where the two touch sensors 171 and 172 divide the display unit 130 into three sections and the user scrolls down the display unit 130, the controller 110 turns on an upper part 1 of the display unit 130 in response to a touch signal inputted from the first touch sensor 171, turns on an intermediate part 2 of the display unit 130 in response to the touch signal inputted from the second touch sensor 172, and turns on a lower part 3 of the display unit 130 when an input of the touch signal from the second touch sensor 172 is terminated. Thus, the entire part of the display unit 130 can be turned on step by step in response to the direction of user gesture.

Alternatively, when the user scrolls up the display unit 130, the controller 110 can turn on the lower portion 3, the intermediate portion 2, and the upper portion 1 of the display unit 130 in a consecutive order. Here, the controller 110 can display pre-set information, e.g., time, date, whether there exists an unread text message or whether a manner mode is set up. Alternatively, when the display unit 130 displaying a particular screen is turned off after a given period of time elapses, the controller 110 can control such that the display unit 130 outputs an image of the screen displayed at the time the display unit 130 is turned off. When the at least part of the display unit 130 is activated and no input is received during a certain period of time, the controller 110 can turn off the entire display unit 130.

Meanwhile, in the above description, a default state of the display unit 130 is described as the turn off state. However, the present invention is not limited to this example. That is, when a signal corresponding to the user gesture is inputted during when the display unit 130 is turned on, the controller 110 can turn off the display unit 130 step by step corresponding to the user gesture. Also, when the touch is detected by at least one of the touch sensors, the controller 110 can activate or deactivate a part of the display unit 130 that is mapped to the at least one touch sensor detecting the touch. Specifically, when a part of the display unit 130 is activated and a signal is inputted from at least one touch sensor located corresponding to a deactivated area of the display unit 130, the controller 110 can activate a corresponding area of the display unit 130. When the signal is inputted from at least one touch sensor located corresponding to an activated area of the display unit 130, the controller 110 can deactivate a corresponding area of the display unit 130.

Although it is described in the above that the display unit 130 is turned on or turned off step by step in response to the user gesture that scrolls the display unit 130 in a vertical direction (i.e., longitudinal direction), the present invention can be applied to the user gesture that scrolls the display unit 130 in a horizontal direction (i.e., transverse direction).

Further, in the description above, the touch sensor unit 170 includes a plurality of the touch sensors to activate the portion of the display unit 130 step by step; however, the present invention should not be construed as being limited to this example. As shown in (d) of FIG. 2, when the touch sensor unit 170 is formed as, for example, the touch pad or the touch panel, the controller 110 can turn on the display unit 130 corresponding to the user gesture in a continuous manner instead of a step by step manner. Specifically, when the touch signal is inputted from the touch pad or the touch panel, the controller 110 can identify a position and a direction of the touch to activate or deactivate at least part of the display unit 130 corresponding to the position and the direction of the touch.

Although not shown in FIG. 1, to provide an additional feature, the portable terminal 100 can further selectively include an element such as a global positioning system (GPS) module for receiving positioning information, a broadcast receiving module for receiving broadcast contents, a digital sound source reproducing module such as an MP3 module and an internet communication module for providing internet access. The elements can vary according to the convergence trend of digital devices, and thus, not all elements are noted. However, the portable terminal 100 according to the present invention may further include structural elements equivalent to the level of foregoing structural elements.

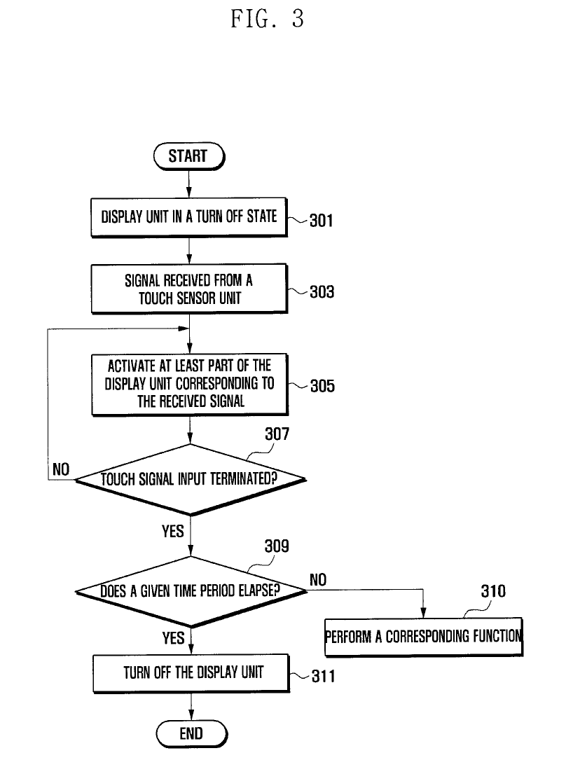

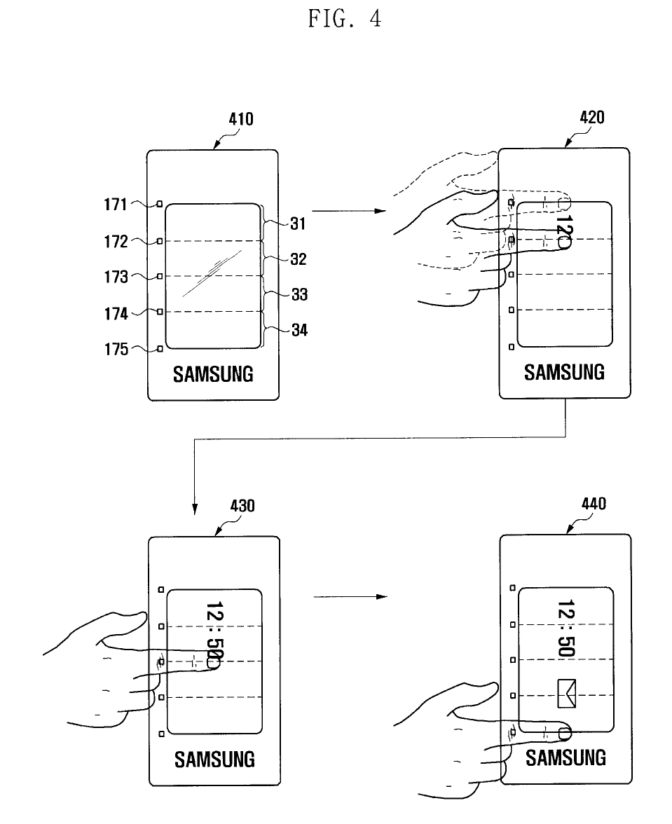

FIG. 3 is a flowchart illustrating a method of controlling a display unit of a portable terminal according to an exemplary embodiment of the present invention, and FIGS. 4 through 7 are views illustrating an example screen display for explaining a method of controlling a display unit of a portable terminal according to an exemplary embodiment of the present invention.

Referring to FIGS. 1 through 7, the display unit 130 for the portable terminal 100 is a turn off state (301) as shown in the screen display 410 of FIG. 4. Here, it is assumed that the touch sensor unit 170 includes five touch sensors 171, 172, 173, 174 and 175 and positioned on a left side of the display unit 130, thus dividing the display unit 130 into four sections, as shown by horizontal lines. That is, the display unit 130 can be divided into a plurality of areas according to the location of the plurality of the touch sensors.

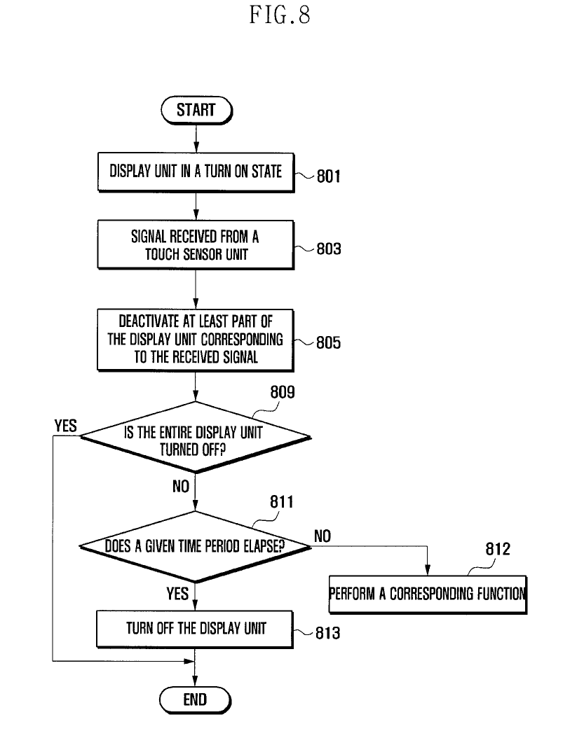

Next, the controller 110 receives a signal corresponding to the user gesture from the touch sensor unit 170 (303) and can activate at least part of the display unit 130 corresponding to the received signal (305). Next, the controller 110 can identify whether a touch signal input according to the user gesture is terminated (307). When the touch signal input is not terminated, the controller 110 can return to step 305. When the touch signal input is terminated, the control until 110 can determine whether a specified period of time elapses (309). When it is determined that the given period of time does not elapse, the controller 110 can perform a corresponding function (310). For example, the controller 110 can output the content of the text message to the display unit 130 according to a user request or turn off a part of the display unit 130 according to the user gesture, which will be described in detail below with reference to FIG. 8. On the other hand, when it is determined that the specified period of time elapses, the controller 110 can turn off the entire display unit 130 (311).

Now, steps 303 through 311 are described with reference to FIG. 4. In the screen display 420 of FIG. 4, when the user consecutively touches the first sensor 171 and the second touch sensor 172, the controller 110 can turn on a first area 31 of the display unit 130. Next, when the user moves his or her hand downward to touch the third touch sensor 173 as shown in the example screen display 430 of FIG. 4, the controller 110 can turn on a second area 32 of the display unit 130. Next, as shown in the example screen display 440 of FIG. 4, when the user moves his or her hand downward to consecutively touch the fourth touch sensor 174 and the fifth touch sensor 175, the controller 110 can consecutively turn on a third area 33 and a fourth area 34 of the display unit 130. Thus, the controller 110 according to the present invention can successively turn on a part of the display unit 130 in response to the user gesture of scrolling the display unit 130 detected by the touch sensor 170. Thereafter, when no input is received during a given period of time (e.g., 15 seconds) in the example screen display 440, the controller 110 turns off the display unit 130, as shown in the example screen displays 410 having the turn off state.

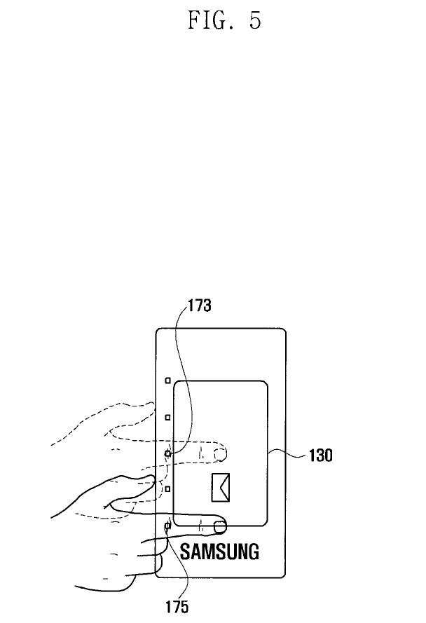

In FIG. 4, it is described that the entire display unit 130 is turned on by consecutively turning on each part of the display unit 130 as the user finger moves across the screen; however, it should be noted that the present invention is not limited to this example. For example, as shown in FIG. 5, when the user touches the third touch sensor 173 through the fifth touch sensor 175 in a consecutive order, the controller 110 can consecutively turn on only the third area 33 and the fourth area 34 of the display unit 130.

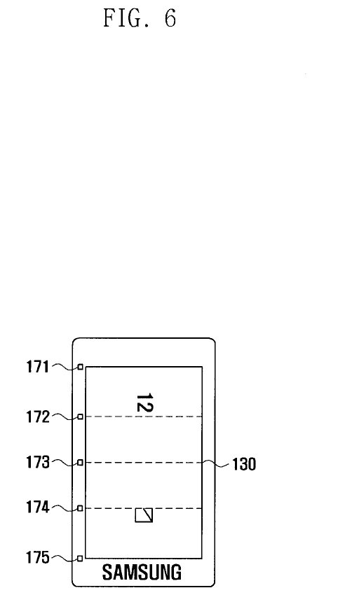

Further, as shown in FIG. 6, when the user touches the first touch sensor 171, the second touch sensor 172, the fourth touch sensor 174, and the fifth touch sensor 175 and does not touch the third touch sensor 173, the controller 110 can turn on only the first area 31 and the fourth area 34 of the display unit 130. That is, when the entire display unit 130 is deactivated and at least one of the touch sensors detects the touch, the controller 110 can activate a part of the display area 130 mapped to the touch sensor that detects the touch.

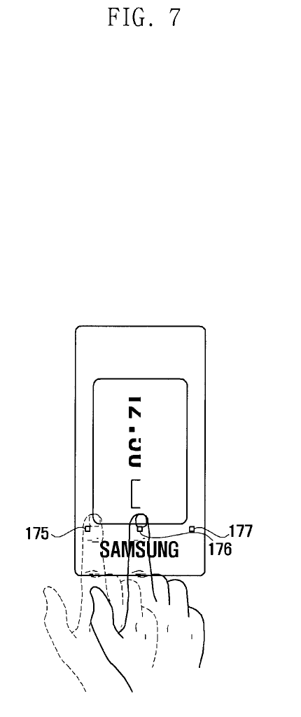

Moreover, as shown in FIG. 7, when a plurality of the touch sensors 175, 176 and 177 are positioned along a horizontal direction of the display unit 130, the present invention can be applied such that at least part of the display unit 130 is turned on in response to the user gesture in a similar manner as described above, except in different orientation. Here, the display unit 130 is divided into multiple sections by vertical directions.

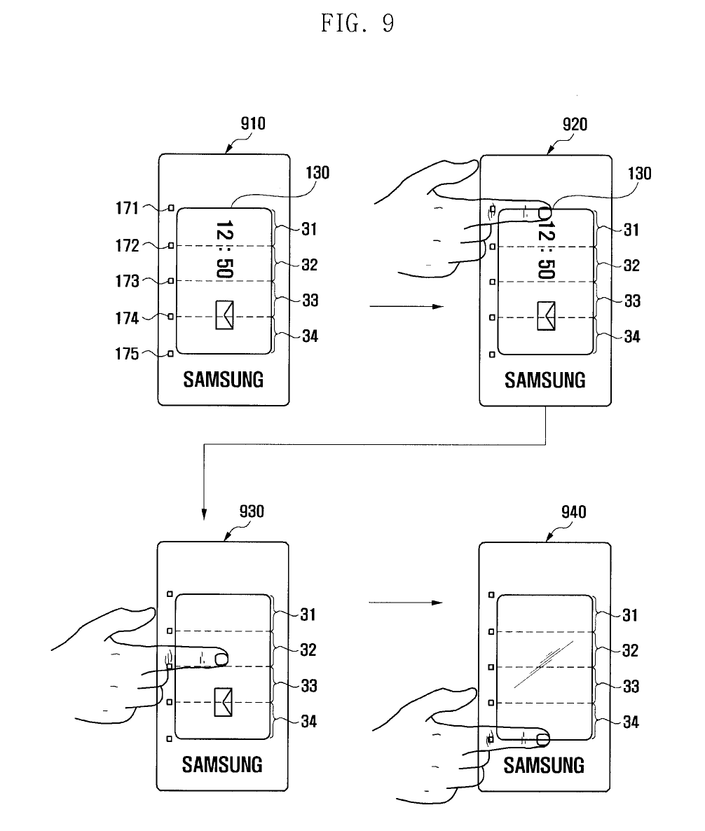

FIG. 8 is a flowchart illustrating a method of controlling a display unit of a portable terminal according to another exemplary embodiment of the present invention, and FIG. 9 is a view illustrating an example screen display for explaining a method of controlling a display unit of a portable terminal according to another exemplary embodiment of the present invention.

Referring to FIGS. 1, 8 and 9, the display unit 130 is on a turn on state (801) as shown in the screen display 910 of FIG. 9. During this state, the display unit 130 may show time or an icon notifying an unread message. Here, it is assumed that the touch sensor unit 170 includes five touch sensors 171, 172, 173, 174 and 175 and positioned on a left side of the display unit 130 to divide the display unit 130 into four sections by horizontal lines.

Next, the controller 110 may receive a signal corresponding to the user gesture from the touch sensor unit 170 (803), and deactivate (or turn off) at least part of the display unit 130 corresponding to the received signal (805). Next, the controller 110 can identify whether the entire display unit 130 is turned off (809). When the entire display unit 130 is turned off, the controller 110 can terminate a process of controlling the display unit 130 corresponding to the user gesture. When the display unit 130 is not turned off, the controller 110 can determine whether a specific period of time elapses (811). When the given period of time does not elapse, the controller 110 can perform a corresponding function (812). For example, when the touch signal is inputted from the touch sensor corresponding to a turn-on area, the controller 110 can turn off the corresponding area of the display unit 130. When the touch signal is inputted from the touch sensor corresponding to a turn-off area, the controller 110 can turn on the corresponding area of the display unit 130. When the specific period of time elapses, the controller 110 can turn off the entire display unit 130 (813).

Now, step 803 through step 813 are described with reference to FIG. 9. In the screen displays 920 and 930 of FIG. 9, when the user consecutively touches the first sensor 171 through the third touch sensor 173 such that the touch signal is subsequently inputted from the first touch sensor 171, the second touch sensor 172 and the third touch sensor 173, the controller 110 can subsequently turn off the first area 31 and the second area 32 of the display unit 130. Thereafter, when the user continuously moves his or her hand downward to touch the fourth touch sensor 174 and the fifth touch sensor 175 as shown in the screen display 940 of FIG. 9, the controller 110 can subsequently turn off the third area 33 and the fourth area 34 of the display unit 130 in sequence. Thus, the entire display unit 130 is turned off. Here, similar to FIG. 6, when the entire display unit 130 is activated and at least one of the touch sensors detects the touch, the controller 110 can deactivate a part of the display unit 130 mapped to the touch sensor that detects the touch.

In the above embodiment, the folder type terminal is provided as an example of controlling the turn on/off of a sub display unit positioned on an external surface of the portable terminal 100. However, it should be noted that the present invention is not limited to this exemplary embodiment. Namely, the present invention can be applied to various portable terminals such as a bar type or a slide type portable terminal. Also, in the above description, the touch sensor unit 170 is described to be mounted on a peripheral area of the display unit 130; however, the present invention is not limited to this exemplary embodiment. Namely, the touch sensor unit 130 can be mounted in various positions of the portable terminal 100.

Further, in the above, a step of turning on the display unit and a step of turning off the display unit are described as separate; however, this should not be construed as limiting the scope of the present invention. For example, the present invention can be applied such that, when a part of the display unit is activated and a signal is inputted from the touch sensor unit located corresponding to a deactivated area, the corresponding area of the display unit may be activated. Also, when a signal is inputted from the touch sensor unit located corresponding to an activated area, the corresponding area of the display unit may be deactivated.

It should be noted that the touch sensor unit 170 described above includes a plurality of the touch sensors. However, when the touch sensor unit 170 is formed as the touch pad or the touch panel and the touch signal is inputted from the touch pad or the touch panel, the controller 110 can identify a position and a direction of the touch (or dragging) to activate or deactivate at least part of the display unit 130 in correspondence with the position and the direction of the touch.

As is apparent from the foregoing, the present invention has an advantages in controlling the display unit of the portable terminal in that a user gesture over the display unit is detected by a touch sensor mounted in a peripheral area of the display unit to turn on or turn off at least part of the display unit, thereby offering a differentiated feature from conventional portable terminals. Accordingly, user satisfaction of the portable terminal can be improved and sales of the portable terminal can be increased due to novel features.

The method of controlling the display unit of the portable terminal according to exemplary embodiments of the present invention may be implemented in the form of a program command executable by various computer means and recorded in a computer readable recording medium. The computer readable recording medium may include program commands, data files, data structures, or the like, alone or a combination thereof. The program commands of the computer readable recording medium may be designed and configured specially for the sake of the present invention, or may be of the kind well-known and readily available to those skilled in the computer software field.

Examples of the computer readable recording medium include magnetic media such as hard disks, floppy disks and magnetic tapes, optical media such as CD-ROMs, DVD, or the like, magneto-optical media such as floptical disks, and hardware devices such as ROMs, RAMs, flash memories, or the like, that are configured specially to store and execute program commands. The program commands include machine language codes as construed by a compiler as well as high-level language codes executable by a computer using interpreters, or the like. The hardware devices described above may be configured to operate as at least one software module to perform the operation of the present invention.

The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of controlling a display unit of a portable terminal, the method comprising:
receiving a signal corresponding to a user gesture from a touch sensor unit provided in the display unit; and
activating or deactivating at least part of the display unit according to the signal received from the touch sensor unit.

2. The method according to claim 1, wherein activating or deactivating the at least part of the display unit comprises:
activating a corresponding part of the display unit when the signal is inputted from the touch sensor unit located corresponding to a deactivated area of the display unit; and
deactivating a corresponding part of the display unit when the signal is inputted from the touch sensor unit located corresponding to an activated area of the display unit.

3. The method according to claim 1, when the at least part of the display unit is activated and no input is received during a predefined time period,
deactivating an entire part of the display unit.

4. An apparatus for controlling a display unit of a portable terminal, comprising:
a touch sensor unit located in a peripheral area of the display unit; and
a controller configured to activate or deactivate at least part of the display unit according to a signal received from the touch sensor unit.

5. The apparatus according to claim 4, wherein the touch sensor unit is positioned in at least one of a top side, a bottom side, a left side, and a right side of the display unit.

6. The apparatus according to claim 4, wherein the touch sensor unit includes a plurality of touch sensors.

7. The apparatus according to claim 6, wherein the display unit is divided into a plurality of areas each of which is mapped to each of the touch sensors, and, when a touch is detected by at least one of the touch sensors, the controller activates or deactivates an area of the display unit that corresponds to the at least one of the touch sensors detecting the touch.

8. The apparatus according to claim 4, wherein the touch sensor unit is a touch pad or a touch panel.

9. The apparatus according to claim 8, wherein, when a touch motion signal is received from the touch pad or the touch panel, the controller identifies a touch position and a touch motion direction to activate or deactivate the at least part of the display unit corresponding to the touch position and the touch motion direction.

10. The apparatus according to claim 4, wherein, when the at least part of the display unit is activated and no input is received during a predefined time period, the controller turns off an entire part of the display unit.

11. A mobile terminal, comprising:
a display unit having a plurality of sensors in a horizontal or vertical orientation, the plurality of sensors defining a plurality of areas for sensing input information; and
a controller configured to receive a signal indicative of movement detected by the plurality of sensors over the plurality of areas and to activate or deactivate at least one of the plurality of areas corresponding to the received signal.

12. The mobile terminal according to claim 11, wherein the at least one of the plurality of areas is activated when the received signal is detected from at least one of the sensors corresponding to a deactivated area of the display unit.

13. The mobile terminal according to claim 11, wherein the at least one of the plurality of areas is deactivated when the received signal is detected from at least one of the sensors corresponding to an activated area of the display unit.

14. The mobile terminal according to claim 11, wherein the controller is further configured to deactivate an entire screen of the display unit when no input is received within a predefined time period during the activated state.

15. The mobile terminal according to claim 11, wherein the display unit comprises a touch pad.

16. The mobile terminal according to claim 15, wherein, when a touch motion signal is received from the touch pad, the controller to activate or deactivate the at least one of the plurality of areas corresponding to a touch position and a touch motion direction.

17. The mobile terminal according to claim 11, wherein the controller configured to activate or deactivate a first area and a second area of the display unit in sequence as the movement is detected by a first sensor and a second sensor.

18. The mobile terminal according to claim 11, wherein the controller configured to activate or deactivate one of the plurality of areas defined by at least two sensors as the movement is detected by the at least two sensors.
